(19) United States
(12) Patent Application Publication
(10) Pub. No.: US 2021/0039153 A1
(43) Pub. Date: Feb. 11, 2021

(54) QUICK CONNECT MECHANISMS FOR DRAW STUD ASSEMBLIES

(71) Applicant: BLACK & DECKER INC., New Britain, CT (US)

(72) Inventors: Jonathan Raymond Siemen, Towson, MD (US); Todd Bogdan Plajzer, Towson, MD (US); Marc Edward Paras, Towson, MD (US); Seth Michael Robinson, York, PA (US); Vincent Cerfeuillet, Maslives (FR); Patrick Vervier, Saint Claude de diray (FR); John Michael Peiffer, Middle River, MD (US); Nancy Ling Chung, Silver Spring, MD (US); Rex Allen Marshall, JR., Dundalk, MD (US)

(21) Appl. No.: 17/012,562

(22) Filed: Sep. 4, 2020

Related U.S. Application Data
(63) Continuation of application No. PCT/US2020/015333, filed on Jan. 28, 2020.
(60) Provisional application No. 62/798,605, filed on Jan. 30, 2019.

(51) Int. Cl. B21D 28/34; B26F 1/14

(52) U.S. Cl. CPC B21D 28/343; B26F 1/14

(57) ABSTRACT

A punch tool assembly for punch cutting a workpiece is disclosed. The punch tool assembly connectable to a movable piston. The punch tool assembly has a draw stud, a removable connector for connecting the draw stud to the piston, and a die receiving the draw stud therethrough. The die is disposed on a side of the workpiece. A quick-release nut engages the draw stud. The nut is disposed on the other side of the workpiece. The nut has threaded nut segments that threadingly engage the draw stud, and at least one spring biasing the nut segments towards each other. A cutter is disposed on the draw stud between the other side of the workpiece and the nut.

### FIELD

The invention relates to quick connect mechanisms, and more particularly to quick connect mechanisms for draw stud assemblies.

### BACKGROUND

Draw stud assemblies are typically used in conjunction with a knockout punch tool for creating holes in a workpiece. Such draw stud assemblies usually include a draw stud, a connector threaded to a first end of the draw stud to facilitate attachment of the draw stud assembly to a movable piston of the punch tool, a die through which the draw stud extends, and a punch threaded to a second end of the draw stud.

In operation, the connector is first threaded to the first end of the draw stud, and the draw stud is inserted through the die. The draw stud is then inserted through a pre-made hole in the workpiece having a nominal diameter sufficient to fit the draw stud and onto the workpiece, with the threaded second end of the draw stud protruding through a hole in the die. The punch is then threaded to the second end of the draw stud to secure the draw stud assembly onto the workpiece, and the connector is attached to the movable piston of the punch tool before the punch tool is actuated. After the punch creates a hole in the workpiece, the draw stud assembly must be disassembled by unthreading the connector, the punch, or both from the draw stud before being reassembled again for a subsequent punching operation.

### DESCRIPTION OF THE DRAWINGS

Preferred embodiments of the invention will now be described, by way of example, with reference to the accompanying drawings, of which:

FIGS. 1A-1B are exploded and assembled side perspective views, respectively, of a draw stud assembly in accordance with the invention;

FIG. 2 is an exploded side view of the draw stud, die, workpiece, cutter and quick-release nut in accordance with the invention;

FIG. 3 is an exploded side view of the quick-release nut of FIG. 2;

FIG. 4 is an alternate side view of a portion of the draw stud assembly;

FIG. 5 is a rear perspective view of the portion of the draw stud assembly of FIG. 4; and

FIG. 6 is a cross-sectional view of the portion of the draw stud assembly of FIG. 4.

### DETAILED DESCRIPTION

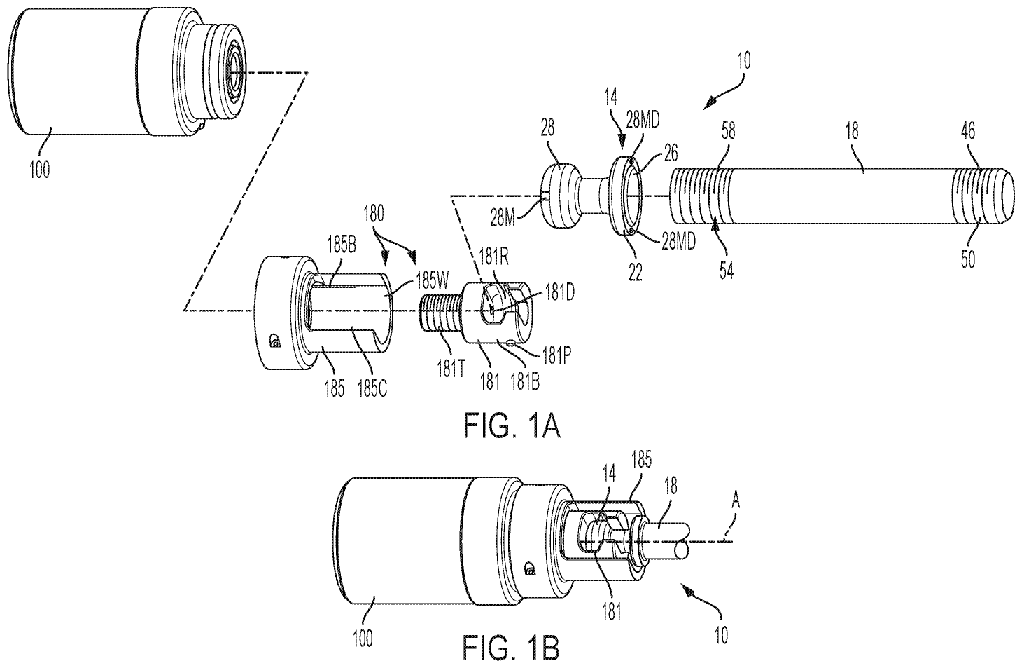

FIGS. 1A-1B illustrate a draw stud assembly 10 for use with a knockout punch tool (partly shown as 100) in punching holes in a workpiece. The assembly 10 includes a draw stud 18 defining a longitudinal axis A and a removable connector, which in the illustrated embodiment of FIG. 1 is a ball pull 14, that secures the draw stud 18 to the knockout punch tool 100.

The ball pull 14 includes a cylindrical body 22 having a cylindrical bore 26, and a ball, spherical- or cylindrical-shaped portion 28 integrally formed with the cylindrical body 22. The ball pull 14 may be threadingly engaged to draw stud 18. Further information on the connection between ball pull 14 and draw stud 18 may be found in US Publication No. 2017/0015016, entitled “Quick Connect Mechanism For A Draw Stud Assembly,” filed on Jul. 14, 2016, which is hereby wholly incorporated by reference.

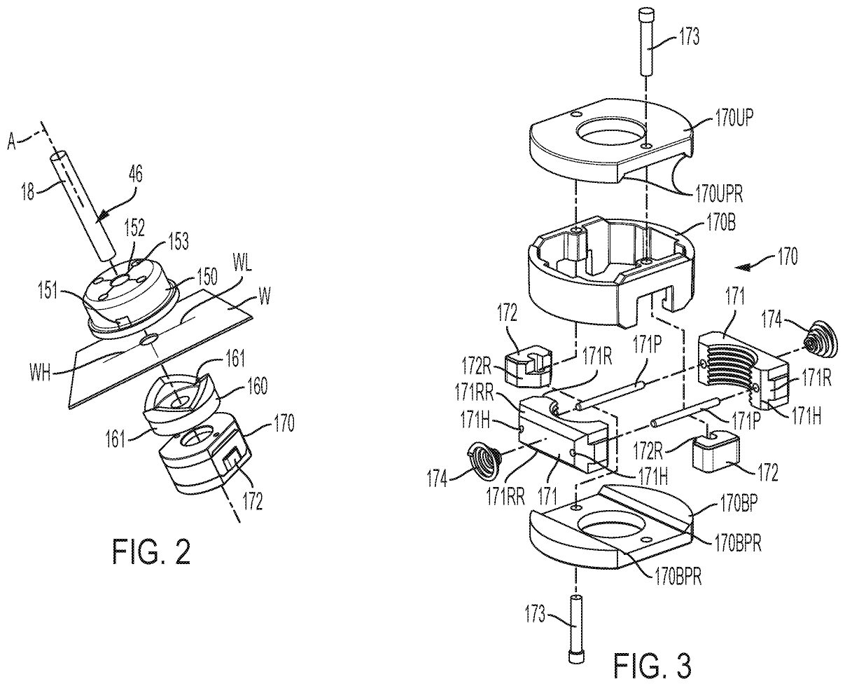

Referring to FIGS. 1A-2, the draw stud 18 may have a first end 46 having fine threads 50, and an opposite, second end 54 having a fine threads 58 that are engageable with the respective fine threads of the ball pull 14.

As shown in FIG. 2, the draw stud 18 (with or without attached ball pull 14) is insertable through a die 150. The stud/die combination is then insertable through a pre-formed hole WH in a workpiece W having a diameter at least nominally greater than that of the draw stud 18.

Die 150 may have indicia, such as cross-hairs, 152, for aligning die 150 to indicia or cross-hairs WL created on workpiece W. Die 150 may have holes 153 for allowing a user to see therethrough and check for alignment with indicia WL. Preferably die 150 has at least one magnet 151 that contacts workpiece W. The user can rotate and translate die 150 until the desired alignment with indicia WL has been attained. Magnet(s) 151 will then keep the die 150 aligned while the stud/die combination assembly continues.

The stud/die combination is then inserted through a cutter 160 on the other side of workpiece W. Cutter 160 may be threaded into draw stud 18. Alternatively, cutter 160 may not have threads for threading unto draw stud 18. Instead, a quick-release nut 170 can then be installed on the first end 46 of the draw stud 18.

Referring to FIGS. 2-3, quick-release nut 170 may have a body 170B with threaded nut segments 171. Pins 171P may be slidably disposed on holes 171H of nut segments 171, allowing nut segments 171 to slide along pins 171P.

Buttons 172 may be provided between nut segments 171. Buttons 172 may have ramps 172R that contact ramps 171R of nut segments 171. Persons skilled in the art shall recognize that, if buttons 172 are pressed (and moved) towards each other, ramps 172R will contact ramps 171R and force nut segments 171 to move apart from each other.

Quick-release nut 170 may also have springs 174 disposed between body 170B and nut segments 171, biasing nut segments 171 towards each other. Accordingly, when the user releases buttons 172, springs 174 will push nut segments 171 towards each other. Ramps 171R will contact ramps 172R and force buttons 172 to move apart from each other.

Most, if not all, of these components are disposed within body 170B. Plates 170UP, 170BP may be disposed on the upper and lower sides of body 170B, respectively, for maintain such components within body 170B. Screws 173 may hold the body 170B and plates 170UP, 170BP together.

Preferably, plates 170UP, 170BP have corresponding ramps 170UPR, 170BPR which interface with ramps 171RR on the nut segments 171. Having ramps 170UP, 170BP and 171R contact each other prevent the nut segments 171 from separating under load during the knockout operation.

With such construction, a user can install quick-release nut 170 on draw stud 18 by pressing buttons 172 and inserting draw stud 18 through quick-release nut 170. When the user has put the quick-release nut 170 on the desired location of draw stud 18 (perhaps against cutter 160), the user can release buttons 172, and the threads of nut segments 171 will mesh with the threads of draw stud 18. Persons skilled in the art shall recognize that plates 170UP, 170BP have the same configuration, so that the quick-release nut 170 can be installed on draw stud 18 regardless of orientation. If desired, the user can further rotate quick-release nut 170 about axis A towards cutter 160.

Persons skilled in the art will recognize that, once the punch operation is complete, the user can disassemble the assembly by pushing the buttons 172 on the quick-release nut 170. This will allow the user to quickly remove quick-release nut 170, further allowing the user to separate cutter 160 from workpiece W, as well as the stud/die combination from workpiece W. The punched portion of the workpiece W must be removed from between the die 150 and cutter 160 before another punch is performed. If desired, the user can remove draw stud 18 from die 150, or can maintain them and insert them together in another hole WH on workpiece W to make another punch operation.

Ball pull 14 (and thus draw stud 18) may be connected to a first cylindrical portion 181. The first cylindrical portion 181 may include a threaded end 181T, which is coupleable to a piston of the knockout punch tool 100, such that the first portion 181 and the piston move together.

The first portion 181 also includes a body 181B defining a recess 181R therein. The recess 181R is substantially spherical or cylindrical in shape and is open both radially and axially. The recess 181R is shaped such that the ball pull 14 can be introduced and removed radially from the recess 181R, but the ball pull 14 cannot be removed axially. As such, any forces applied axially to the first portion 181 are transmitted into the ball pull 14 (and thus draw stud 18), such as when the draw stud 18 is being drawn during the punching process.

First portion 181 may have a spring-loaded detent 181D (see, e.g., FIGS. 1A and 6) that contacts and engages a depression in portion 28 for maintaining portion 28 within first portion 181. Persons skilled in the art shall recognize that detent 181D may alternatively be disposed on portion 28 for engaging a depression in first portion 181. Alternatively (or in addition), portion 28 and/or first portion 181 may be provided with a magnet 28M for maintaining together portion 28 and first portion 181.

Persons skilled in the art shall recognize that one or more magnets 28MD may also be provided on cylindrical body 22. Magnets 28MD may magnetically engage and hold die 150 in place relative to draw stud 18 while the stud/die combination is inserted through a cutter 160 on the other side of workpiece W.

The second portion 185 at least partially encompasses the first portion 181. The second portion 185 preferably includes an annular wall 185W that forms a cut-out 185C therein. When assembled, the second portion 185 may be rotatable with respect to the first portion 181 between an aligned position and an un-aligned position. Persons skilled in the art are referred to U.S. Pat. No. 9,782,909, which is wholly incorporated by reference, for further information on such arrangement. Alternatively, first portion 181 may have at least one pin 181P. Pin(s) 181P may engage slot(s) 185S on second portion 185 so that first and second portions 181, 185 cannot rotate relative to each other.

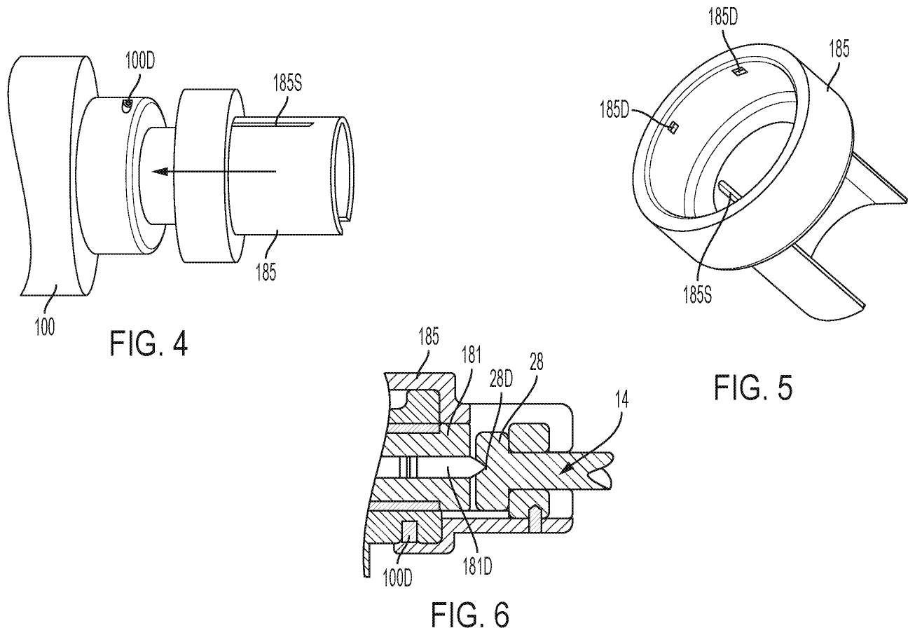

FIGS. 4-6 show an alternate embodiment of second portion 185.

Knockout punch tool 100 may have a spring-loaded detent 100D. Second portion 185 may be pushed into knockout punch tool 100. Detent 100D preferably contacts and engages a depression 185D in second portion 185 for maintaining second portion 185 in a desired position relative to first portion 181 and/or knockout punch tool 100. Second portion 185 may have multiple depressions 185D, allowing the user to rotate second portion 185 relative to knockout punch tool 100 from a first detented position to a second detented position. Persons skilled in the art shall recognize that detent 100D may alternatively be disposed on second portion 185 for engaging a depression 185D in knockout punch tool 100.

It will be understood that the above description and the drawings are examples of particular implementations of the invention, but that other implementations of the invention are included in the scope of the claims.

What is claimed is:

1: A punch tool assembly connectable to a movable piston for punch cutting a workpiece, the punch tool assembly comprising:
a draw stud;
a removable connector for connecting the draw stud to the piston;
a die receiving the draw stud therethrough, the die being disposed on a side of the workpiece;
a quick-release nut engaging the draw stud, the nut being disposed on an other side of the workpiece, the nut comprising threaded nut segments that threadingly engage the draw stud, and at least one spring biasing the nut segments towards each other; and
a cutter disposed on the draw stud, the cutter being disposed between the other side of the workpiece and the nut.

2: The punch tool assembly of claim 1 wherein the nut further comprises at least one button for moving the nut segments away from each other.

3: The punch tool assembly of claim 1, wherein the die has indicia thereon.

4: The punch tool assembly of claim 1, wherein the die further comprises a magnet contacting the workpiece.

5: The punch tool assembly of claim 1, wherein the connector includes a cylindrical body.

6: The punch tool assembly of claim 5, wherein the connector includes a ball-shaped portion extending from an end of the cylindrical body.

7: The punch tool assembly of claim 6, wherein the connector includes an axial opening on an end of the cylindrical body, and a recess extending transversely through the cylindrical body to the axial opening.

8: The punch tool assembly of claim 7, further comprising a ball pull directly attachable to the movable piston, wherein the ball pull includes a ball-shaped portion insertable through the recess and into the axial opening of the connector, wherein the axial opening is sized to inhibit the ball-shaped portion from being removed axially from the connector.

9: The punch tool assembly of claim 8, wherein a width of the recess is greater than a width of the ball-shaped portion of the ball pull, and wherein a width of the axial opening is less than the width of the ball-shaped portion.

10: The punch tool assembly of claim 8, wherein the connector further includes a detent for contacting a depression in the ball-shaped portion.

11: The punch tool assembly of claim 8, wherein the connector further includes at least one magnet provided on the cylindrical body.
